(19) United States
(12) Patent Application Publication
(10) Pub. No.: US 2005/0186377 A1
(43) Pub. Date: Aug. 25, 2005

(54) Solventless plastic bonding of medical devices and container components through infrared heating

(76) Inventors: William S. Hurst, Burlington, WI (US); Michael W. Scharf, McHenry, IL (US); Steven Giovanetto, Vernon Hills, IL (US); Larry Rosenbaum, Gurnee, IL (US); Rob Clarke, Libertyville, IL (US); Kim Hansford, Winthrop Harbor, IL (US); Brad Buchanan, Ross, CA (US); Sue Rosenbaum, (US)

Correspondence Address: BAXTER HEALTHCARE CORPORATION, 1 BAXTER PARKWAY, DF2-2E, DEERFIELD, IL, 60015, US

(21) Appl. No.: 10/783,379

(22) Filed: Feb. 19, 2004

(51) Int. Cl. B32B 1/08

(52) U.S. Cl. 428/36.9

(57) ABSTRACT

The present invention provides a method for preparing solventless bonds between plastic components. The method includes the step of using infrared exposure to create bonds, and more specifically, the step of exposing a first article and/or a second article to a specific portion of the infrared spectrum. The invention further provides medical devices fabricated using infrared exposure.

### CROSS-REFERENCE TO RELATED APPLICATIONS

Not Applicable.

### FEDERALLY SPONSORED RESEARCH OR DEVELOPMENT

Not Applicable.

### BACKGROUND OF THE INVENTION

The present invention is concerned with a method for bonding plastic components without the need for solvents. The method includes using infrared heat and in some cases precision located infrared absorbing pigment for creating a bond. The method is preferably used to prepare strong, long-lasting bonds between various types of medical devices and containers.

There are numerous types of medical devices which are made from multiple plastic components. Ordinarily, these components must then be joined together in some manner before the device is operable. Currently there are several bonding techniques prevalently used including mechanical, thermal, solvent, and chemical adhesive. It is a requirement that the bonding technique chosen must not only provide a secure bond which meets all of the parameters of the specific application, but must also not interfere with the function or safety standards of the device.

Solvent bonding is one technique that is commonly used in joining component parts of medical devices. Some of the advantages of solvent bonding are that it is relatively simple to perform, requires inexpensive materials, and is usually quick to perform. However, recently there has been an ever increasing move within the medical device industry away from solvent bonding.

Another technique frequently used in the medical device industry is adhesive bonding. Some common adhesives used include epoxies, polyurethanes, silicones, and acrylics. However, some of these adhesives pose safety risks. For example, polyurethanes can contain toxic heavy-metal catalysts that pose serious problems in some medical device applications. In addition to safety concerns, another significant limitation of commonly used adhesives is that many can only be used for disposable devices. This limitation in part is due to the fact that many adhesives cannot tolerate repeated sterilization. Accordingly, there is a need to provide an alternative to the previously used bonding techniques which does not suffer from these above-mentioned drawbacks.

### SUMMARY OF THE INVENTION

Described herein is a method for assembling a medical device including the steps of: providing a first article of a polymeric material; providing a second article of a polymeric material; contacting the first article with the second article along an interface area; and exposing the first article and the second article to a specific portion of the infrared spectrum where the polymeric material of the first article and the polymeric material of the second article absorb infrared energy in order to generate sufficient heat to create a bond between the first article and the second article.

Further set forth herein is a method for assembling a medical device including the steps of: providing a first article of a polymeric material; providing a second article of a polymeric material; attaching the first article to the second article along an interface area; and exposing either the first or the second article to a specific portion of the infrared spectrum where the polymeric material of the first article or the polymeric material of the second article absorb infrared energy in order to generate sufficient heat to create a bond between the first and the second article.

Further described herein is a method for assembling a medical device including the steps of: providing a first article of a polymeric material; providing a second article of a polymeric material; applying an infrared absorbing pigment to one of the first article or the second article to define an interface area; contacting the first article with the second article along the interface area; and bonding the first article to the second article along the interface area using infrared exposure.

Further described herein is a method for assembling a medical device including the steps of: providing a first article of a polymeric material, providing a second article of a polymeric material, providing an infrared responsive pigmented film, placing the infrared responsive pigmented film between the first article and the second article to define an interface area and contacting the first article with the second article, and applying infrared exposure to bond the first article and the second article.

Further described herein is a medical device assembly including a first article of a polymeric material; a second article of a polymeric material; the first or second article having an infrared absorbing pigment disposed thereon to define an interface area, the first article being contacted with the second article at the interface area; and a protective shield temporarily placed over at least a portion of the interface area, such that when infrared heat is applied to the interface area a bond is formed between the first article and the second article.

Further described herein is a medical device assembly of a first article of a polymeric material; a second article of a polymeric material; the first or second article having an infrared absorbing pigment disposed thereon to define an interface area, the first article being contacted with the second article at the interface area; and a protective shield temporarily placed over at least a portion of the interface area, such that when infrared heat is applied to the interface area a bond is formed between the first article and the second article.

Further described herein is a medical device assembly of a first article of a polymeric material, a second article of a polymeric material, either the first or second article having an infrared absorbing pigment disposed thereon to define an interface area, the first article being fixedly attached to the second article at the interface area by applying infrared exposure.

Additional features and advantages of the present invention are described in, and will be apparent from, the following Detailed Description of the Invention and the Figures.

### BRIEF DESCRIPTION OF THE FIGURES

FIG. 1A and FIG. 1B are respectively cross-sectional views of a monolayer, non-PVC, weldable tubing and a multiple layer tubing having the monolayer tubing as a layer therein for use with the method of the present invention.

FIG. 2 is a cross-sectional view of a flexible material container and a port closure assembly for use with the method of the present invention.

FIG. 3A is a cross-sectional view of a closure assembly having a membrane tube and two-layered port tube for use with the method of the present invention.

FIG. 3B is a cross-sectional view of an embodiment of a closure assembly of the present invention.

FIG. 4 is a cross-sectional view of a closure assembly having a membrane tube and a three-layered port tube for use with the method of the present invention.

FIG. 5A is a cross-sectional view of a tubing assembly in which an inside tube has an infrared absorbing pigment layer on an outside surface.

FIG. 5B is a cross-sectional view of a tubing assembly in which an outside tube has an infrared absorbing pigment layer on an inside surface.

FIG. 5C is a cross-sectional view of a tubing assembly in which both an outside tube and an inside tube have an infrared absorbing pigment layer.

FIG. 6A and FIG. 6B are a schematic plan view and a front perspective view of one embodiment of a protective shield according to principles of the present invention.

FIG. 7A and FIG. 7B are a schematic plan view and a front perspective view of another embodiment of a protective shield according to principles of the present invention.

FIG. 8A and FIG. 8B are a schematic plan view and a front perspective view of still yet another embodiment of a protective shield according to principles of the present invention.

FIG. 9A and FIG. 9B are a schematic plan view and a front perspective view of still yet another embodiment of a protective shield according to principles of the present invention.

FIG. 10A and FIG. 10B are a schematic plan view and a front perspective view of still yet another embodiment of a protective shield according to principles of the present invention.

FIG. 11A and FIG. 11B are front plan views showing a method of bonding two membrane tubes using the protective shield of the present invention.

FIG. 12 is a front perspective view showing an infrared responsive pigment ring insert molded into a flanged port.

FIG. 13 is a schematic plan view of an infrared responsive pigmented film being used to bond a flanged port to a medical film.

FIG. 14 is a schematic plan view of a flanged port having an infrared absorbing pigment printed on a surface which is to be bonded to a surface of a medical film.

FIG. 15 is a schematic plan view of a flanged port having infrared absorbing pigment printed on a surface being bonded to a surface of a medical film using a protective shield in accordance with the present invention.

FIG. 16A and FIG. 16B are schematic plan views of a method of bonding a flanged port having infrared absorbing pigment printed on a bottom surface thereof to a surface of a filled medical container using a protective shield according to the present invention.

FIG. 17A and FIG. 17B are front plan views of a tubing assembly before heating and after the infrared heat welding process exhibiting unacceptable distortion.

FIG. 18 is a front perspective view showing a method of spraying an infrared pigment on a medical device according to the present invention.

FIG. 19 is a plot of bond strength vs. carbon black by mass.

### DETAILED DESCRIPTION OF THE INVENTION

While this invention is susceptible of embodiment in many different forms, there is shown in the drawing, and will be described herein in detail, specific embodiments thereof with the understanding that the present disclosure is to be considered as an exemplification of the principles of the invention and is not intended to limit the invention to the specific embodiments illustrated.

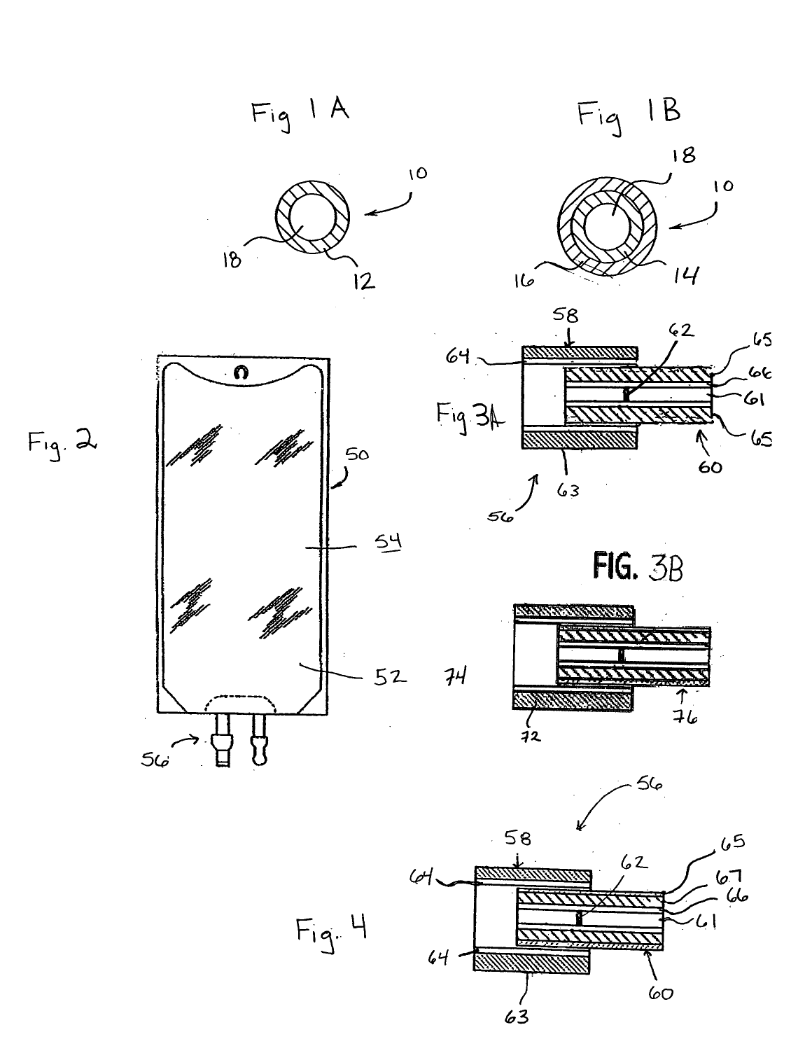

FIG. 1A shows a monolayer tubing that is suitable for use with the present invention. The monolayer tubing 10 has a sidewall 12 made from a polymeric material and more preferably from a non-PVC containing polymer and most preferably from a non-PVC containing polymer that is capable of heating upon exposure to an infrared source (“IR responsive”).

FIG. 1B shows a two layer tubing 10 having a first layer or solution contact layer 14 and a second layer 16. At least one of the layers 14 or 16 is composed of a non-PVC containing polymer that is IR responsive. In a preferred form, the other layer 14 or 16 will also be a non-PVC containing polymer, and more preferably a non-PVC containing polymer that is IR responsive. However, it may also be desirable to have a solution contact layer 14 that is not IR responsive or does not contain any components that may leach into solution or react with the solution. Of course, it is contemplated that tubing having more than two-layers can be used without departing from the scope of the present invention. The tubing sidewalls define a fluid pathway 18 therethrough.

Suitable non-PVC containing polymers include polyolefins, ethylene and lower alkyl acrylate copolymers, ethylene and lower alkyl substituted alkyl acrylate copolymers, ethylene vinyl acetate copolymers, polybutadienes, polyesters, polyamides, and styrene and hydrocarbon copolymers.

Suitable polyolefins include homopolymers and copolymers obtained by polymerizing alpha-olefins containing from 2 to 20 carbon atoms, and more preferably from 2 to 10 carbons. Therefore, suitable polyolefins include polymers and copolymers of propylene, ethylene, butene-1, pentene-1,4-methyl-1-pentene, hexene-1, heptene-1, octene-1, nonene-1 and decene-1. Most preferably the polyolefin is a homopolymer or copolymer of propylene or a homopolymer or copolymer of polyethylene.

Suitable homopolymers of polypropylene can have a stereochemistry of amorphous, isotactic, syndiotactic, atactic, hemiisotactic or stereoblock. In a more preferred form, the polypropylene will have a low heat of fusion from about 20 joules/gram to about 220 joules/gram, more preferably from about 60 joules/gram to about 160 joules/gram and most preferably from about 80 joules/gram to about 130 joules/gram. It is also desirable, in a preferred form, for the polypropylene homopolymer to have a melting point temperature of less than about 165° C. and more preferably from about 130° C. to about 160° C., more preferably from about 140° C. to about 150° C. In one preferred form of the invention, the homopolymer of polypropylene is obtained using a single site catalyst.

Suitable copolymers of propylene are obtained by polymerizing a propylene monomer with an α-olefin having from 2 to 20 carbons. In a more preferred form of the invention, the propylene is copolymerized with ethylene in an amount by weight from about 1% to about 20%, more preferably from about 1% to about 10% and most preferably from 2% to about 5% by weight of the copolymer. The propylene and ethylene copolymers may be random or block copolymers. The propylene copolymer should have a low heat of fusion of from about 40 joules/gram to about 140 joules/gram, more preferable from about 60 joules/gram to about 90 joules/gram. In a preferred form of the invention, the propylene copolymer is obtained using a single-site catalyst.

It is also possible to use a blend of polypropylene and α-olefin copolymers wherein the propylene copolymers can vary by the number of carbons in the α-olefin. For example, the present invention contemplates blends of propylene and α-olefin copolymers wherein one copolymer has a 2 carbon α-olefin and another copolymer has a 4 carbon α-olefin. It is also possible to use any combination of α-olefins from 2 to 20 carbons and more preferably from 2 to 8 carbons. Accordingly, the present invention contemplates blends of propylene and α-olefin copolymers wherein a first and second α-olefins have the following combination of carbon numbers: 2 and 6, 2 and 8, 4 and 6, 4 and 8. It is also contemplated using more than 2 polypropylene and α-olefin copolymers in the blend. Suitable polymers can be obtained, for example, using a catalloy procedure.

It may also be desirable to use a high melt strength polypropylene. High melt strength polypropylenes can be a homopolymer or copolymer of polypropylene having a melt flow index within the range of 10 grams/10 min. to 800 grams/10 min., more preferably 30 grams/10 min. to 200 grams/10 min, or any range or combination of ranges therein. High melt strength polypropylenes are known to have free-end long chain branches of propylene units. Methods of preparing polypropylenes which exhibit a high melt strength characteristic have been described in U.S. Pat. Nos. 4,916,198; 5,047,485; and 5,605,936 which are incorporated herein by reference and made a part hereof. One such method includes irradiating a linear propylene polymer in an environment in which the active oxygen concentration is about 15% by volume with high energy ionization energy radiation at a dose of 1 to 10⁴ megarads per minute for a period of time sufficient for a substantial amount of chain scission of the linear propylene polymer to occur but insufficient to cause the material to become gelatinous. The irradiation results in chain scission. The subsequent recombination of chain fragments results in the formation of new chains, as well as joining chain fragments to chains to form branches. This further results in the desired free-end long chain branched, high molecular weight, non-linear, propylene polymer material. Radiation is maintained until a significant amount of long chain branches form. The material is then treated to deactivate substantially all the free radicals present in the irradiated material.

High melt strength polypropylenes can also be obtained as described in U.S. Pat. No. 5,416,169, which is incorporated in its entirety herein by reference and made a part hereof, when a specified organic peroxide (di-2-ethylhexyl peroxydicarbonate) is reacted with a polypropylene under specified conditions, followed by melt-kneading. Such polypropylenes are linear, crystalline polypropylenes having a branching coefficient of substantially 1, and, therefore, has no free end long-chain branching and will have a intrinsic viscosity of from about 2.5 dl/g to 10 dl/g.

Suitable homopolymers of ethylene include those having a density of greater than 0.915 g/cc and includes low density polyethylene (LDPE), medium density polyethylene (MDPE) and high density polyethylene (HDPE).

Suitable copolymers of ethylene are obtained by polymerizing ethylene monomers with an α-olefin having from 3 to 20 carbons, more preferably 3-10 carbons and most preferably from 4 to 8 carbons. It is also desirable for the copolymers of ethylene to have a density as measured by ASTM D-792 of less than about 0.915 g/cc and more preferably less than about 0.910 g/cc and even more preferably less than about 0.900 g/cc. Such polymers are oftentimes referred to as VLDPE (very low density polyethylene) or ULDPE (ultra low density polyethylene). Preferably, the ethylene α-olefin copolymers are produced using a single site catalyst and even more preferably a metallocene catalyst systems. Single site catalysts are believed to have a single, sterically and electronically equivalent catalyst position as opposed to the Ziegler-Natta type catalysts which are known to have a mixture of catalysts sites. Such single-site catalyzed ethylene α-olefins are sold by Dow under the trade name AFFINITY, DuPont Dow under the trademark ENGAGE® and by Exxon under the trade name EXACT. These copolymers shall sometimes be referred to herein as m-ULDPE.

Suitable copolymers of ethylene also include ethylene and lower alkyl acrylate copolymers, ethylene and lower alkyl substituted alkyl acrylate copolymers and ethylene vinyl acetate copolymers having a vinyl acetate content of from about 8% to about 40% by weight of the copolymer. The term “lower alkyl acrylates” refers to comonomers having the formula set forth in Diagram 1:

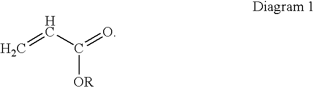

The R group refers to alkyls having from 1 to 17 carbons. Thus, the term “lower alkyl acrylates” includes but is not limited to methyl acrylate, ethyl acrylate, butyl acrylate and the like.

The term “alkyl substituted alkyl acrylates” refers to comonomers having the formula set forth in Diagram 2:

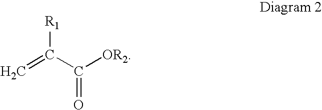

R₁ and R₂ are alkyls having 1-17 carbons and can have the same number of carbons or have a different number of carbons. Thus, the term “alkyl substituted alkyl acrylates” includes but is not limited to methyl methacrylate, ethyl methacrylate, methyl ethacrylate, ethyl ethacrylate, butyl methacrylate, butyl ethacrylate and the like.

Suitable polybutadienes include the 1,2- and 1,4-addition products of 1,3-butadiene (these shall collectively be referred to as polybutadienes). In a more preferred form of the invention, the polymer is a 1,2-addition product of 1,3 butadiene (these shall be referred to as 1,2 polybutadienes). In an even more preferred form of the invention, the polymer of interest is a syndiotactic 1,2-polybutadiene and even more preferably a low crystallinity, syndiotactic 1,2 polybutadiene. In a preferred form of the invention, the low crystallinity, syndiotactic 1,2 polybutadiene will have a crystallinity less than 50%, more preferably less than about 45%, even more preferably less than about 40%, even more preferably the crystallinity will be from about 13% to about 40%, and most preferably, from about 15% to about 30%. In a preferred form of the invention, the low crystallinity, syndiotactic 1,2 polybutadiene will have a melting point temperature measured in accordance with ASTM D 3418 from about 70° C. to about 120° C. Suitable resins include those sold by JSR (Japan Synthetic Rubber) under the grade designations: JSR RB 810, JSR RB 820, and JSR RB 830.

Suitable polyesters include polycondensation products of di-or polycarboxylic acids and di or poly hydroxy alcohols or alkylene oxides. In a preferred form of the invention, the polyester is a polyester ether. Suitable polyester ethers are obtained from reacting 1,4 cyclohexane dimethanol, 1,4 cyclohexane dicarboxylic acid and polytetramethylene glycol ether and shall be referred to generally as PCCE. Suitable PCCE's are sold by Eastman under the trade name ECDEL. Suitable polyesters further include polyester elastomers which are block copolymers of a hard crystalline segment of polybutylene terephthalate and a second segment of a soft (amorphous) polyether glycols. Such polyester elastomers are sold by DuPont Chemical Company under the trade name HYTREL®.

Suitable polyamides include those that result from a ring-opening reaction of lactams having from 4-12 carbons. This group of polyamides therefore includes nylon 6, nylon 10 and nylon 12. Acceptable polyamides also include aliphatic polyamides resulting from the condensation reaction of di-amines having a carbon number within a range of 2-13, aliphatic polyamides resulting from a condensation reaction of di-acids having a carbon number within a range of 2-13, polyamides resulting from the condensation reaction of dimer fatty acids, and amide containing copolymers. Thus, suitable aliphatic polyamides include, for example, nylon 66, nylon 6,10 and dimer fatty acid polyamides.

The styrene of the styrene and hydrocarbon copolymer includes styrene and the various substituted styrenes including alkyl substituted styrene and halogen substituted styrene. The alkyl group can contain from 1 to about 6 carbon atoms. Specific examples of substituted styrenes include alpha-methylstyrene, beta-methylstyrene, vinyltoluene, 3-methylstyrene, 4-methylstyrene, 4-isopropylstyrene, 2,4-dimethylstyrene, o-chlorostyrene, p-chlorostyrene, o-bromostyrene, 2-chloro-4-methylstyrene, etc. Styrene is the most preferred.

The hydrocarbon portion of the styrene and hydrocarbon copolymer includes conjugated dienes. Conjugated dienes which may be utilized are those containing from 4 to about 10 carbon atoms and more generally, from 4 to 6 carbon atoms. Examples include 1,3-butadiene, 2-methyl-1,3-butadiene (isoprene), 2,3-dimethyl-1,3-butadiene, chloroprene, 1,3-pentadiene, 1,3-hexadiene, etc. Mixtures of these conjugated dienes also may be used such as mixtures of butadiene and isoprene. The preferred conjugated dienes are isoprene and 1,3-butadiene.

The styrene and hydrocarbon copolymers can be block copolymers including di-block, tri-block, multi-block, and star block. Specific examples of diblock copolymers include styrene-butadiene, styrene-isoprene, and the hydrogenated derivatives thereof. Examples of triblock polymers include styrene-butadiene-styrene, styrene-isoprene-styrene, alpha-methylstyrene-butadiene-alpha-methylstyrene, and alpha-methylstyrene-isoprene-alpha-methylstyrene and hydrogenated derivatives thereof.

The selective hydrogenation of the above block copolymers may be carried out by a variety of well known processes including hydrogenation in the presence of such catalysts as Raney nickel, noble metals such as platinum, palladium, etc., and soluble transition metal catalysts. Suitable hydrogenation processes which can be used are those wherein the diene-containing polymer or copolymer is dissolved in an inert hydrocarbon diluent such as cyclohexane and hydrogenated by reaction with hydrogen in the presence of a soluble hydrogenation catalyst. Such procedures are described in U.S. Pat. Nos. 3,113,986 and 4,226,952, the disclosures of which are incorporated herein by reference and made a part hereof.

Particularly useful hydrogenated block copolymers are the hydrogenated block copolymers of styrene-isoprene-styrene, such as a styrene-(ethylene/propylene)-styrene block polymer. When a polystyrene-polybutadiene-polystyrene block copolymer is hydrogenated, the resulting product resembles a regular copolymer block of ethylene and 1-butene (EB). As noted above, when the conjugated diene employed is isoprene, the resulting hydrogenated product resembles a regular copolymer block of ethylene and propylene (EP). One example of a commercially available selectively hydrogenated block copolymer is KRATON G-1652 which is a hydrogenated SBS triblock comprising 30% styrene end blocks and a midblock equivalent is a copolymer of ethylene and 1-butene (EB). This hydrogenated block copolymer is often referred to as SEBS. Other suitable SEBS or SIS copolymers are sold by Kuraray under the tradename SEPTON® and HYBRAR®.

It may also be desirable to use graft modified styrene and hydrocarbon block copolymers by grafting an alpha,beta-unsaturated monocarboxylic or dicarboxylic acid reagent onto the selectively hydrogenated block copolymers described above.

The block copolymers of the conjugated diene and the vinyl aromatic compound are grafted with an alpha,beta-unsaturated monocarboxylic or dicarboxylic acid reagent. The carboxylic acid reagents include carboxylic acids per se and their functional derivatives such as anhydrides, imides, metal salts, esters, etc., which are capable of being grafted onto the selectively hydrogenated block copolymer. The grafted polymer will usually contain from about 0.1 to about 20%, and preferably from about 0.1 to about 10% by weight based on the total weight of the block copolymer and the carboxylic acid reagent of the grafted carboxylic acid. Specific examples of useful monobasic carboxylic acids include acrylic acid, methacrylic acid, cinnamic acid, crotonic acid, acrylic anhydride, sodium acrylate, calcium acrylate and magnesium acrylate, etc. Examples of dicarboxylic acids and useful derivatives thereof include maleic acid, maleic anhydride, fumaric acid, mesaconic acid, itaconic acid, citraconic acid, itaconic anhydride, citraconic anhydride, monomethyl maleate, monosodium maleate, etc.

The styrene and hydrocarbon block copolymer can be modified with an oil such as the oil modified SEBS sold by the Shell Chemical Company under the product designation KRATON G2705.

In one preferred form of the invention, the tubing is composed of a multiple component polymer blend. The present invention contemplates blending two or more of any of the polymers set forth above. In a preferred form of the invention, the polymer blend includes a polyolefin blended with a styrene and hydrocarbon copolymer. In a preferred form of the invention, the polyolefin is a propylene containing polymer and can be selected from the homopolymers and copolymers of propylene described above including high melt strength polypropylenes. It may also be desirable to have three or more components including a styrene and hydrocarbon copolymer with a blend of various types of polypropylenes. The polypropylene, either alone or in sum, can be present in an amount by weight of the blend from about 10% to about 50%, more preferably from about 15% to about 45% and most preferably from about 20% to about 40% with the balance of the blend being the styrene and hydrocarbon block copolymer.

When using oil modified SEBS it may be desirable, though not critical, to use a high melt strength polypropylene as a blend component. Suitable polypropylene and SEBS containing blends include: (1) precompounded blends of PP and SEBS sold by Wittenburg under the trade name CAWITON and particularly grades PR 3670E and PR4977; (2) from 90-98% by weight KRATON G2705 with 2-10% Basell PROFAX PF 611 high melt strength polypropylene; (3) 75% KRATON G2705 with 23% Basell PROFAX SA 861 random copolymer of propylene and ethylene with 2% Basell PROFAX PF-611 which is high melt strength PP; and (4) precompounded blend of PP/SEBS sold by J-Von under grade 70585 E.

In another preferred form of the invention, the tubing will be fabricated from a single m-ULDPE resin or a blend of m-ULDPE resins. One particularly suitable m-ULDPE resin is sold by DuPont-Dow under the trademark ENGAGE® and even more particularly ENGAGE® 8003 (density 0.885 g/cc). It is also contemplated blending more than one m-ULDPE resins. Such resins and tubings and film made therefrom are more fully set forth in U.S. Pat. No. 6,372,848 which is incorporated in its entirety herein by reference and made a part hereof.

It is also contemplated fabricating tubing from polybutadienes or blends of polybutadiene resins described above.

While the suitable non-PVC containing polymers and polymer blends are typically infrared responsive, to some extent, one may optionally incorporate into the polymer or polymer blend an infrared responsive component. Suitable infrared responsive components include dyes, additives, agents, primers, colorants, and/or pigments. In a more preferred form of the invention, the infrared responsive material is a pigment that is responsive to infrared exposure at a wavelength, or a narrow range of wavelengths, within a range of wavelengths in the near infrared spectrum and more preferably from about 700 nm to about 1500 nm. In a preferred form of the invention, the pigment is responsive to infrared exposure at peak wavelengths from about 780 nm to about 1000 nm and generates sufficient heat over a short period of time to allow for melting of the non-PVC polymer or polymer blend. What is meant by short period of time is less than 8 seconds, more preferably about 6 seconds, and most preferably 2 seconds.

The pigments for use with the present invention preferably absorb IR and are chemically inert. The pigments are also preferably thermally stable at temperatures reached during extrusion processing of the polymer or polymer blend. Suitable pigments are sold by Lancer Dispersions, Inc. of Akron, Ohio.

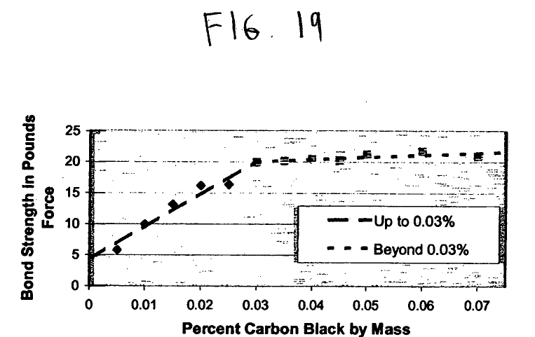

In another preferred form of the invention, the IR responsive material will be applied to a surface of materials to be joined instead of incorporating the IR responsive material into the blend. To this end, the IR responsive material is dissolved or suspended in a suitable carrier or solvent, and, in this form can be applied specifically to selected portions of the surfaces to be joined. The IR responsive material can be applied by dipping the surfaces to be joined into the IR responsive material, or the IR responsive material can be brushed on, sprayed on, printed on or the like, as seen in FIG. 17.

The present invention further contemplates increasing the IR responsiveness of a tubing layer by adjusting the crystallinity of a material, by orienting the tubing or by quenching the material during manufacture.

The tubings of the present invention can be manufactured by any known polymer processing technique, but, in a preferred form of the invention, is formed by extrusion, coextrusion or injection molding. Such tubings are soft, flexible, kink resistant, have a good touch feeling (haptics), and are capable of being sterilized by steam sterilization, radiation or by ethylene oxide (EtO) exposure.

FIG. 2 shows a flowable material container that is suitable for use with the present invention. The flowable material container 50 has sidewalls 52 sealed along peripheral edges to define a chamber 54 there between. A closure assembly 56 provides access to the contents of the container. The container 50 is preferably fabricated from a non-PVC containing material. In a preferred form of the invention, the sidewalls 52 are fabricated from a multiple component polymer alloy disclosed in detail in U.S. Pat. No. 5,686,527 which is incorporated herein by reference and made a part hereof. One particularly suitable polymer alloy is a blend of polypropylene, ultra-low density polyethylene, a dimer fatty acid polyamide and a styrene and hydrocarbon block copolymer. The container 50 shown in FIG. 2 is particularly suitable for medical applications such as storage and delivery of various medical solutions including but not limited to I.V. solutions, peritoneal dialysis solutions, pharmaceutical drugs and blood, blood components, and blood substitutes to name a few. It is contemplated that such a container can also be used to store food products or other consumable products.

What is meant by “flowable material” is a material that will flow by the force of gravity. Flowable materials therefore include both liquid items and powdered or granular items and the like.

FIG. 3 shows the closure assembly 56. The closure assembly 56 has a port tube 58 and a membrane tube 60 coaxially mounted therein. A fluid passageway 61 of the membrane tube 60 is sealed by a membrane 62 positioned at an intermediate portion of the membrane tube 60. For medical applications, the membrane 62 can be punctured by a spike of an infusion set to place the contents of the container into fluid communication with, for example, the vascular system of a patient being treated.

In a preferred form of the invention, the port tube 58 is a multilayered structure and more preferably has a first layer 63 and a second layer 64. The first layer 63 should be of a non-PVC containing material that is capable of being sealed to the sidewalls 52 of the container 50, using infrared bonding sealing techniques or RF sealing or heat conductive type. In a preferred form of the invention, the first layer 63 is a polymer blend of: (a) from about 25% to about 50% by weight and more preferably from about 30% to about 40% by weight, of the first layer a first polyolefin selected from the group consisting of propylene containing polymers, (b) from about 0 to about 50% by weight, and more preferably from about 5-40% by weight, of the first layer a second polyolefin of an α-olefin containing polymer or copolymer and more preferably is an ethylene and α-olefin copolymer; (c) from about 0% to about 40% by weight, and more preferably from about 10% to about 40% by weight, of the first layer a radio frequency susceptible polymer selected from the group consisting of polyamides, ethylene acrylic acid copolymers, ethylene methacrylic acid copolymers, polyamides, polyurethanes, polyesters, polyureas, ethylene vinyl acetate copolymers with a vinyl acetate comonomer content from 18-50% by weight of the copolymer, ethylene methyl acrylate copolymers with methyl acrylate comonomer content from 18%-40% by weight of the copolymer, ethylene vinyl alcohol with vinyl alcohol comonomer content from 15%-70% by mole percent of the copolymer; and (d) from about 0% to about 40% by weight, and more preferably from 10% to about 40% by weight, of the first layer of a thermoplastic elastomer.

One particularly suitable blend for the port tube first layer is a four component blend having by weight the following components: from about 10% to about 40% and more preferably 30% of a dimer fatty acid polyamide, from about 0% to about 50% and more preferably from about 0% to about 10% of an ultra low density polyethylene, from about 25% to about 50% and more preferably from about 30% to about 40% of a polypropylene and from about 10% to about 40% and more preferably 30% styrene-ethylene-butylene-styrene block copolymer with maleic anhydride functionality.

The second layer 64 of the port tube 58 is of a non-PVC containing material that is capable of being bonded in accordance with the present invention to the membrane tube 60. In a preferred form of the invention, the second layer 64 is a multiple component blend of the following components by weight: from about 25% to about 55% and more preferably from 33%-52% of a thermoplastic elastomer, from about 20% to about 45% and more preferably from about 25% to about 42% of a polyester polyether block copolymer, from about 0% to about 15% and more preferably from about 5% to about 12% by weight of the second layer of an ethylene copolymerized with vinyl lower alkyl esters and preferably vinyl acetate, from about 0% to about 10% by weight and more preferably from about 1% to about 5% by weight of the second layer of a propylene containing polymer and from about 0% to about 35% by weight of a polymer selected from the group consisting of acrylonitrile butadiene styrene (ABS) block copolymer, styrene ethylene butylene copolymer, styrene acrylonitrile copolymer and cyclic olefin or bridged polycylic olefin containing polymers.

One particularly suitable blend of the second layer 64 of the port tube is a five-component blend having from about 33% to about 35% SEBS (KRATON® 1660), from about 25% to about 29% polyester polyether block copolymers (HYTREL®), from about 5% to about 9% EVA, from about 1% to about 3% polypropylene and from about 28% to about 32% ABS.

Another suitable blend of the second layer 64 of the port tube 58 is a four-component blend having from about 48% to about 52% SEBS, from about 36% to about 42% polyester polyether block copolymer, from about 8% to about 12% EVA and from about 1% to about 4% polypropylene.

The membrane tube 60 should be fabricated from a non-PVC containing material and should be capable of being bonded, preferably using solventless bonding techniques, to the port tube 58. In a preferred form of the invention, the membrane tube 60 is a multilayered structure. The membrane tube 60 has an outer layer 65 and an inner layer 66. The outer layer 65 is of a material selected from the same materials as set forth for the second layer 64 of the port tube. Likewise, the inner layer 66 of the membrane tube 60 is selected from the same materials as the first layer 63 of the port tube 58.

A particularly suitable inner layer 66 of the membrane tube 60 is a four-component blend by weight of the inner layer 66 that slightly varies from the most preferred first layer of the port tube. The components are by weight of the inner layer 66 as follows: 40% polypropylene, 40% ultra-low density polyethylene, 10% polyamide and 10% SEBS. It should be understood, however, that the inner layer 66 of the membrane tube could also be selected from the same components and weight percentage ranges as set forth above for the first layer of the port tube.

In a preferred form of the invention, the outer layer of the membrane tube should have a thickness from about 15 mils to about 35 mils and more preferably from about 20 mils to about 30 mils. The inner layer of the membrane tube should have a thickness from about 2 mils to about 12 mils and more preferably from about 5 mils to about 10 mils.

FIG. 4 shows an alternate embodiment of the membrane tube having three layers. In addition to the outer layer 65 and inner layer 66 shown in FIG. 3, FIG. 4 shows an intermediate layer 67 interposed therebetween. The intermediate layer 67 preferably is a thermoplastic elastomer and more preferably an oil modified styrene-ethylene-butylene-styrene block copolymer sold by the Shell Chemical Company under the product designation KRATON G2705. The intermediate layer 67 can also be a blend of from about 99% to about 70% of a thermoplastic elastomer and from about 1% to about 30% of a propylene containing polymer.

In yet another preferred form of the invention (FIG. 3B), the port tube 70 is a multilayered structure and more preferably has a first layer 72 and a second layer 74. The first layer 72 should be of a non-PVC containing material that is capable of being sealed to the sidewalls 12 and 14 of the container 10. In a preferred form of the invention, the first layer 72 is a polymer blend of: (a) from about 25% to about 50%, more preferably from about 30% to about 40%, by weight of the first layer a first polyolefin selected from the group consisting of polypropylene and polypropylene copolymers, (b) from about 0% to about 50%, more preferably from about 5% to about 40%, by weight of the first layer a second polyolefin of an α-olefin containing polymer or copolymer and more preferably is an ethylene and α-olefin copolymer; (c) from about 0% to about 40%, more preferably from about 10% to about 40% of the first layer a radio frequency susceptible polymer selected from the group consisting of polyamides, ethylene acrylic acid copolymers, ethylene methacrylic acid copolymers, polyimides, polyurethanes, polyesters, polyureas, ethylene vinyl acetate copolymers with a vinyl acetate comonomer content from 12% to 50% by weight of the copolymer, ethylene methyl acrylate copolymers with methyl acrylate comonomer content from 12% to 40% by weight of the copolymer, ethylene vinyl alcohol with vinyl alcohol comonomer content from 12% to 70% by mole percent of the copolymer; and (d) from about 0% to about 40%, more preferably from about 10% to about 40% of a thermoplastic elastomer by weight of the first layer.

The second layer 74 of the port tube 70 is of a non-PVC containing material that is capable of being solvent bonded to the membrane tube. In a preferred form of the invention, the second layer 74 is a thermoplastic elastomer or a blend of a thermoplastic elastomer in an amount by weight of from about 80% to about 100% and a propylene containing polymer from about 0% to about 20% by weight of the second layer 74. It is also desirable, but optional, that the second layer 74 softens slightly at autoclave temperatures so that when the port tube and membrane tube assembly is steam sterilized, the port tube more tightly adheres to the membrane tube.

As shown in FIG. 3B, the first layer 72 has a thickness greater than the second layer 74. In a preferred form of the invention the first layer will have a thickness of from about 15 mils to about 40 mils and more preferably from about 20 mils to about 30 mils. The second layer will have a thickness from about 2 mils to about 10 mils and more preferably from about 3 mils to about 7 mils.

The membrane tube 76 should be fabricated from a non-PVC containing material. In a preferred form of the invention, the membrane tube 76 is a multilayered structure having an outer layer 80, a core layer 82 and an inner layer 84. In a preferred form of the invention, the outer layer 80 is a polymer blend of: (a) from about 0% to about 60%, more preferably from about 20% to about 55% and most preferably from about 30% to about 50%, by weight of the outer layer of a polyolefin and (b) from about 40% to about 100%, more preferably from about 45% to about 80% and most preferably from about 50% to about 70%, by weight of the outer layer of a thermoplastic elastomer.

Also, in a preferred form of the invention the core layer 82 is a polymer blend of: (a) from about 35% to about 100%, more preferably from about 50% to about 90% and most preferably 70% to about 90%, by weight of the core layer of a thermoplastic elastomer and (b) from about 0% to about 65%, more preferably from about 10% to about 50% and most preferably from about 10% to about 30%, by weight of the core layer of a polyolefin.

Also, in a preferred form of the invention, the inner layer 84 is a polymer blend of: (a) from about 25% to about 55%, more preferably from about 25% to about 40%, by weight of the inner layer a polyolefin; (b) from about 0% to about 50%, more preferably from about 0% to about 40% and most preferably 0% to about 20%, by weight of the inner layer a polyolefin selected from the group consisting of α-olefin containing polymers or copolymers and more preferably is an ethylene and α-olefin copolymer; (c) from about 0% to about 40% by weight, more preferably from about 15% to about 40%, of the inner layer a radio frequency susceptible polymer selected from the group consisting of polyamides, ethylene acrylic acid copolymers, ethylene methacrylic acid copolymers, polyimides, polyurethanes, polyesters, polyureas, ethylene vinyl acetate copolymers with a vinyl acetate comonomer content from 12% to 50% by weight of the copolymer, ethylene methyl acrylate copolymers with methyl acrylate comonomer content from 12% to 40% by weight of the copolymer, ethylene vinyl alcohol with vinyl alcohol comonomer content from 12% to 70% by mole percent of the copolymer; and (d) from about 0% to about 40%, more preferably from about 15% to about 40%, by weight of the inner layer of a thermoplastic elastomer.

In a preferred form of the invention, the outer layer 80 will have a thickness from about 3 mils to about 15 mils and more preferably from about 3 mils to about 10 mils. The core layer 82 will have a thickness from about 10 mils to about 35 mils and more preferably from about 10 mils to about 30 mils. The inner layer 84 will have a thickness from about 3 mils to about 15 mils and more preferably from about 5 mils to about 10 mils.

Suitable propylene containing polymers include homopolymers, copolymers and terpolymers of propylene. Suitable comonomers are one or more α-olefins having from 2 to 17 carbons and most preferably is ethylene in an amount by weight from about 1% to about 8% by weight of the copolymer. Suitable propylene containing polymers include those sold by Solvay under the tradename FORTILENE and include from about 1.0% to about 4.0% ethylene by weight of the copolymer.

Suitable α-olefin containing polymers include homopolymers, copolymers and interpolymers of α-olefins having from 2 to 17 carbons. Suitable ethylene α-olefin copolymers have a density, as measured by ASTM D-792, of less than about 0.915 g/cc and are commonly referred to as very low density polyethylene (VLDPE), linear low density polyethylene (LLDPE), ultra low density polyethylene (ULDPE) and the like. In a preferred form of the invention, the ethylene and α-olefin copolymers are obtained using single site catalysts. Suitable catalyst systems, among others, are those disclosed in U.S. Pat. Nos. 5,783,638 and 5,272,236. Suitable ethylene and α-olefin copolymers include those sold by Dow Chemical Company under the AFFINITY tradename, DuPont-Dow under the ENGAGE tradename, Exxon under the EXACT tradename and Phillips Chemical Company under the tradename MARLEX.

Suitable polyamides include those selected from a group consisting of: aliphatic polyamides resulting from the condensation reaction of di-amines having a carbon number within a range of 2-13, aliphatic polyamides resulting from a condensation reaction of di-acids having a carbon number within a range of 2-13, polyamides resulting from the condensation reaction of dimer fatty acids, and amide containing copolymers. Polyamides resulting from a ring opening operation of a cyclic amides such as a ε-caprolactam is also suitable. In a preferred form of the invention, the polyamide is a dimer fatty acid polyamide sold by Henkel under the tradename MACROMELT. Suitable thermoplastic elastomers of the present invention include styrene and hydrocarbon copolymers, and EPDM. The styrene can be substituted or unsubstituted styrene. The styrene and hydrocarbon copolymers can be a block copolymer including di-block, tri-block, star block, it can also be a random copolymer and other types of styrene and hydrocarbon copolymers that are known by those skilled in the art. The styrene and hydrocarbon copolymers can also contain various types of the above-identified styrene and hydrocarbon copolymers. The styrene and hydrocarbon copolymers can be functionalized by carboxylic acid groups, anhydrides of carboxylic acids, esters of carboxylic acids, epoxy groups and carbon monoxide. In a preferred form of the invention, the thermoplastic elastomer of the first layer 63 of the port tube 58 and the inner layer 66 of the membrane tube 60 is a blend SEB di-block copolymer and SEBS tri-block. Such a copolymer is sold by Shell Chemical Company under the tradename KRATON® FG1924X. The preferred thermoplastic elastomer of the second layer 64 of the port tube 58 and the outer layer 65 of the membrane tube 60 is an SEBS copolymer. Such a tri-block copolymer is sold by, for example, Shell Chemical Company under the tradename KRATON® 1660.

Suitable polyester polyether block copolymers have are sold by DuPont under the tradename HYTREL and particularly HYTREL 4056.

The term “vinyl lower alkyl esters” include those having the formula set forth in Diagram 3:

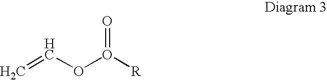

The R in Diagram 3 refers to alkanes having from 1 to 17 carbons. Thus, the term “vinyl lower alkyl esters” includes but is not limited to vinyl methanoate, vinyl acetate, vinyl propionate, vinyl butyrate and the like. In a preferred form of the invention, the ethylene and vinyl lower alkyl ester of the second layer 24 of the port tube 18 and the outer layer 26 of the membrane tube 20 is an ethylene and vinyl acetate copolymer having from about 12% to about 40% vinyl acetate comonomer by weight of the copolymer. Suitable ethylene and vinyl acetate copolymers are sold by Quantum under the product designations LJE634 and UE697.

Suitable ABS copolymers include acrylonitrile butadiene styrene triblock copolymers.

Suitable cyclic olefin or bridged polycyclic hydrocarbon containing polymers and blends thereof can be found in copending U.S. Pat. Nos. 5,218,049; 5,854,349; 5,863,986; 5,795,945; 5,792,824; 6,297,322; EP 0 291,208; EP 0 283,164; and EP 0 497,567 which are incorporated in their entirety herein by reference and made a part hereof. In a preferred form, these homopolymers, copolymers and polymer blends will have a glass transition temperature of greater than 50° C., more preferably from about 70° C. to about 180° C., a density greater than 0.910 g/cc and more preferably from 0.910g/cc to about 1.3 g/cc and most preferably from 0.980 g/cc to about 1.3 g/cc and have from at least about 20 mole % of a cyclic aliphatic or a bridged polycyclic in the backbone of the polymer more preferably from about 30-65 mole % and most preferably from about 30-60 mole %.

In a preferred form of the polymeric blends for use with the present invention, suitable cyclic olefin monomers are monocyclic compounds having from 5 to about 10 carbons in the ring. The cyclic olefins can selected from the group consisting of substituted and unsubstituted cyclopentene, cyclohexene, cycloheptene, and cyclooctene. Suitable substituents include lower alkyl, acrylate derivatives and the like.

In a preferred form of the polymeric blends, suitable bridged polycyclic hydrocarbon monomers have two or more rings and more preferably contain at least 7 carbons. The rings can be substituted or unsubstituted. Suitable substitutes include lower alkyl, aryl, aralkyl, vinyl, allyloxy, (meth)acryloxy and the like. The bridged polycyclic hydrocarbons are selected from the group consisting of those disclosed in the above incorporated patents and patent applications. Suitable bridged polycyclic hydrocarbon containing polymers are sold by Ticona under the tradename TOPAS, by Nippon Zeon under the tradename ZEONEX and ZEONOR, by Daikyo Gomu Seiko under the tradename CZ resin, and by Mitsui Petrochemical Company under the tradename APEL. Suitable comonomers include α-olefins having from 3-10 carbons, aromatic hydrocarbons, other cyclic olefins and bridged polycyclic hydrocarbons.

It may also be desirable to have pendant groups associated with the cyclic olefin containing polymers and bridged polycyclic containing hydrocarbons. The pendant groups are for compatibilizing the cyclic olefin containing polymers and the bridged polycyclic hydrocarbon containing polymers with more polar polymers including amine, amide, imide, ester, carboxylic acid and other polar functional groups. Suitable pendant groups include aromatic hydrocarbons, carbon dioxide, monoethylenically unsaturated hydrocarbons, acrylonitriles, vinyl ethers, vinyl esters, vinylamides, vinyl ketones, vinyl halides, epoxides, cyclic esters and cyclic ethers. The monethylencially unsaturated hydrocarbons include alkyl acrylates, and aryl acrylates. The cyclic ester includes maleic anhydride.

The port tube and the membrane tube are preferably fabricated using coextrusion techniques well known to those skilled in the polymer fabrication art. The membrane tube is bonded to the port tube by attaching the membrane tube to the port tube and exposing the interface area to a specific portion of the infrared spectrum as discussed in detail below. In addition, infrared absorbing pigments may be incorporated into the polymer blends for the port tube and membrane tube to further facilitate bond formation.

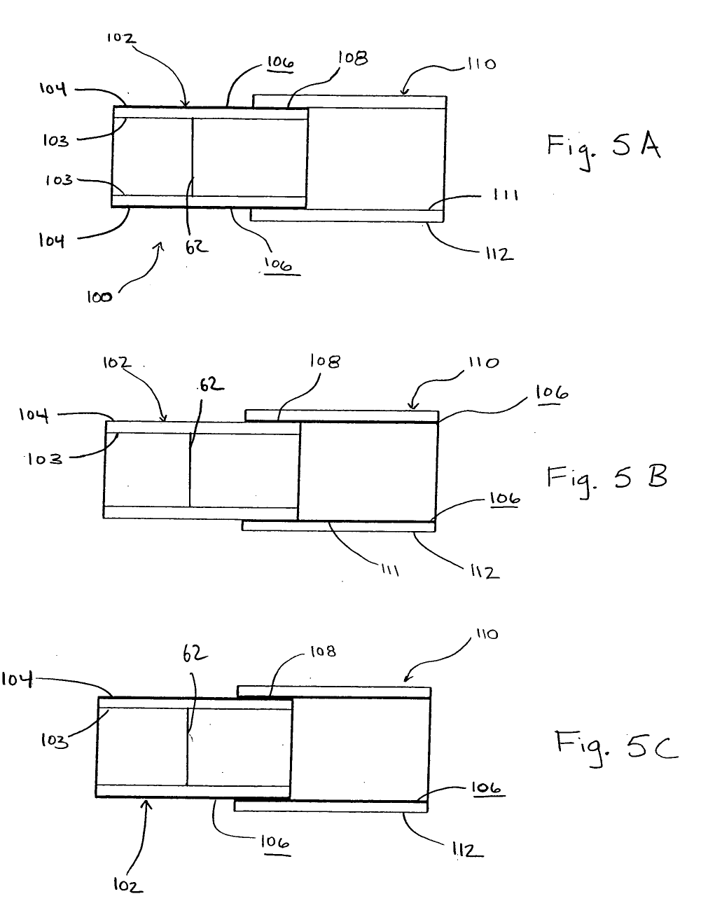

Referring now to FIGS. 5A-5C, a medical tubing assembly 100 in accordance with the present invention is disclosed. In this example, the tubing assembly includes a pair of centrally mounted tubes. The membrane can be mono- or multilayer and are preferably fabricated from polymeric materials previously discussed. The tubes are designed to be interconnected so that there is an inside tube 102 which fits inside of an outside tube 110. The outside tube 110 has an inside layer 111 and an outside layer 112. The inside tube 102 also has an inside layer 103 and an outside layer 104. The tubing assemblies of FIGS. 5A-5C differ in the location of a pigment layer 06. In FIGS. 5A and 5B, a single pigment layer is used. In FIG. 5C, two pigment layers are present. In FIG. 5A, the pigment layer 106 forms an outer layer of inside tube 102. In FIG. 5B, the pigment layer 106 forms an inside layer of outside tube 110. In FIG. 5C, interfacing layers of pigment are shown.

The pigment layer 106 may be printed onto the tubes 110 and/or 102 after fabrication (FIG. 17) or applied by adding infrared absorbing pigment(s) directly into polymer blends used to fabricate the tubes as discussed in detail above. In cases where the infrared pigment is printed onto the tube, it can be printed onto a first area in a first concentration and in a second area at a concentration lower than the first concentration. It is further envisioned that the tubes may include no infrared absorbing pigments. More specifically, where the polymeric materials themselves absorb infrared light, little or no pigment may be needed.

According to the method of the present invention, the inside tube 102 is inserted into the outside tube 110 to define an interface area 108. The interface area 108 acts as a bonding area for holding the tubes together. Once the inside tube 102 is inserted inside the outside tube 110, either the inside tube 102 or the outside tube 110 is then exposed to a specific portion of the infrared or near infrared spectrum where the pigment layer 106 of either the inside tube 108 or the outside tube 110 absorbs infrared energy. The infrared exposure is designed to generate sufficient heat to create a bond between the inside tube 102 and the outside tube 110 at the interface area 112. In a preferred form of the invention, the infrared energy will be at a wavelength of from about 0.075 to about 1.0 microns.

Alternatively, if both the inside tube 102 and the outside tube 108 include pigment layers 106, then both can be exposed to a portion of the infrared or near infrared spectrum where the pigment layers 106 absorb infrared energy in order to generate the necessary heat to create a bond between the inside 102 and outside tube 110. In cases where the pigment layer 106 is provided in different concentrations, the tubing assembly 100 may be exposed to a first infrared exposure to create a first seal and then a second exposure to create a second seal. In this regard, a first hybrid bond could be created initially and a final higher strength bond could be created during sterilization. In the case where no infrared pigment layer is included in either the outside tube 110 or the inside tube 102, one must select a portion of the infrared or near infrared spectrum where the polymeric materials themselves will absorb enough infrared light in order to generate the necessary heat to create a bond.

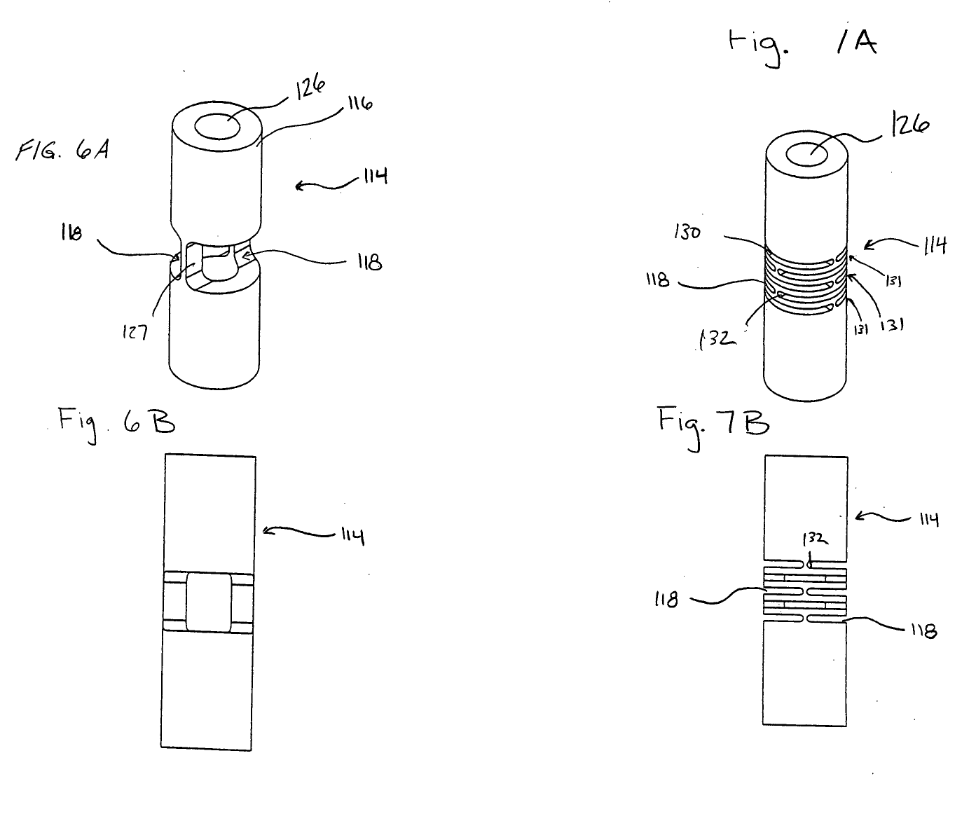

While the above-mentioned method works effectively with most polymeric materials, some materials can stress relieve to create unacceptable distortion during the infrared heat welding process as seen in FIGS. 17A-B. FIG. 17A shows a tubing assembly prior to IR welding and FIG. 17B shows the assembly after IR welding. Thus, it may be desirable to provide a shield 114 (FIGS. 6-10) which can protect a non-bonding area, while allowing infrared light to reach the bonding area 108. In this regard, the shield constrains the bond area, thus helping the components maintain a functional geometry during and after the heating process. In the illustrated embodiment, the shield 114 is tube shaped and includes a diameter 126 which is larger than the diameter of the inside tube 102 and the outside tube 110 of the tubing assembly 100 (FIGS. 11A-B). This allows the shield 114 to slide over the tubing assembly 100. The diameter 126 of the shield can be varied so that different amounts of infrared energy reach the tube assembly 100, essentially shielding some parts and permitting exposure to others. The shield 114 is designed such that the main body 116 includes a thick wall section 120 which inhibits some transmission of infrared energy to protect a non-bonding area and prevent unacceptable distortion. The main body 116 further includes a thinner wall section 122 which constrains the bonding area 124 while also permitting infrared transmission to reach the bonding area, thus generating sufficient heat to create a bond.

In yet other preferred embodiments (FIGS. 6A-10B), the shield 114 includes a main body 116 and also includes a plurality of side windows 118. As discussed above, the main body 116 of the shield 114 protects a non-bonding area by either reflecting infrared light away or inhibiting transmission. In contrast, the side windows 118 are designed to permit infrared exposure to reach the bonding area and create a bond.

FIGS. 6A, 6B have two opposed windows 118 separated by narrow pillars 127 to allow exposure around more than 90% of the circumference of the tubing. FIGS. 7A, 7B show the window 118 having a plurality of arcuate-shaped, circumferentially extending slits 130. The slits are positioned in vertically spaced groups 131, each group having one slit or more than one slit having individual slits in each group circumferentially spaced from one another. The slits are generally narrow, extend from about 10° to about 350°, more preferably from about 30° to 270°, and most preferably from about 90° to about 180°. The slits are generally constant in height across their length and have generally rounded end sections 132. FIGS. 9A and 9B are yet another embodiment having circumferentially extending slits in vertically spaced relationship with each slit extending about the entire circumference of the shield 114.

FIGS. 8A, 8B, 10A, 10B, show the window 118 having a plurality of circumferentially spaced and axially extending slits. The slits are shown spaced at approximately 60° intervals but could be any of slits provided a tubing assembly can be effectively sealed with IR exposure. The slits of FIGS. 8A, 8B are narrow and have rounded end sections 132. The slits of FIGS. 10A, 10B are generally rectangularly shaped.

The slits described herein can be arranged axially and can have varied width and pitch to provide bonds of varying strength, as demonstrated in FIGS. 9A-B. To this end, the bonds formed can be either hermetic or not hermetic depending on the size and shape of the side widows 118. The shield 114 can be composed of any material which exhibits good transmission of infrared light including such materials as glass, or the like. However, the shield 114 is most preferably composed of polytetrafluoroethylene, commonly referred to as TEFLON®, which is commercially available from DuPont. TEFLON® is an ideal material since it exhibits good transmission of infrared light and is easy to clear from welded components because of its relative lubricity.

Referring now generally to FIGS. 12-16, various methods according to the present invention are provided for bonding a flanged port 200 to a medical device. The flanged port 200 is generally fabricated from the polymeric materials discussed in detail above and may or may not include an infrared absorbing pigment to facilitate bonding. In one example, an infrared responsive pigmented ring 202 is insert molded onto the base 201 of the flanged port 200, as seen in FIG. 12. Once the infrared pigment is attached to the flanged port 200, the flanged port 200 is then attached to a medical device such as a medical film (not shown) and bonded using infrared exposure as was discussed in detail above.

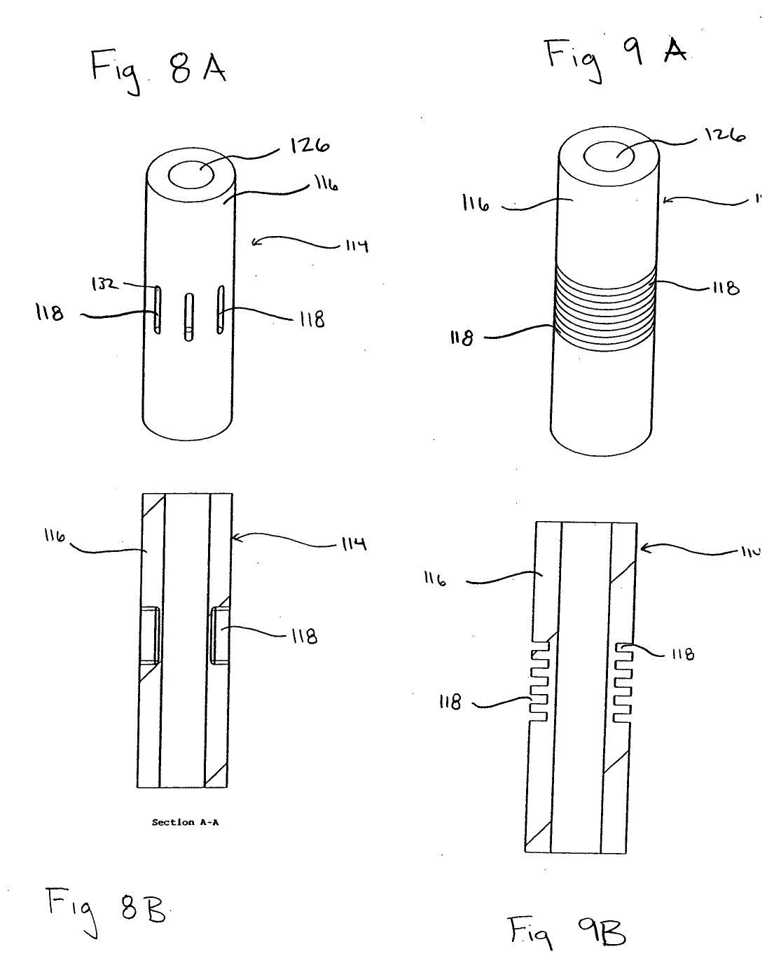

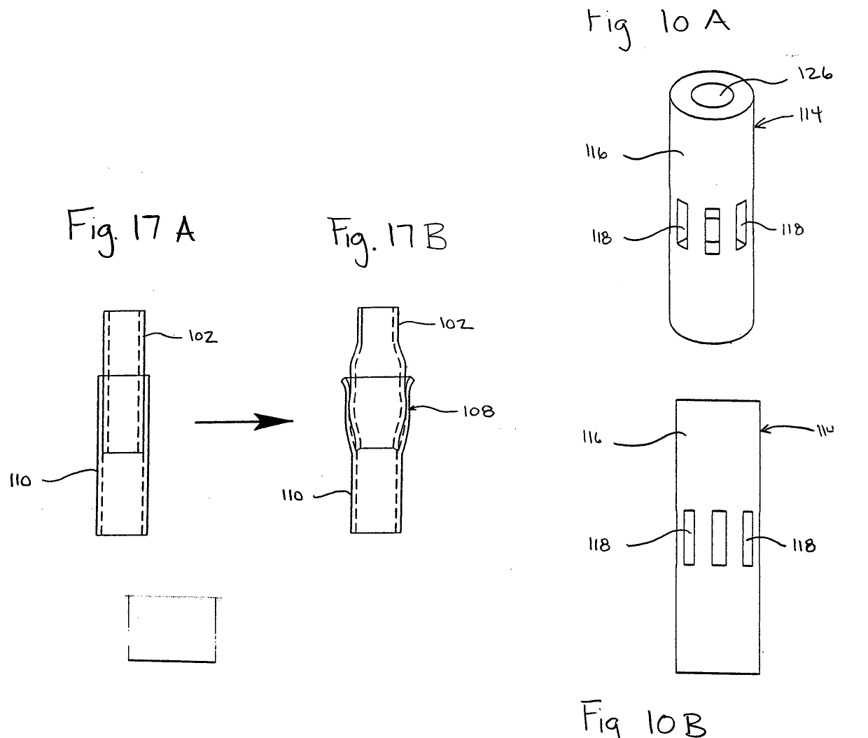

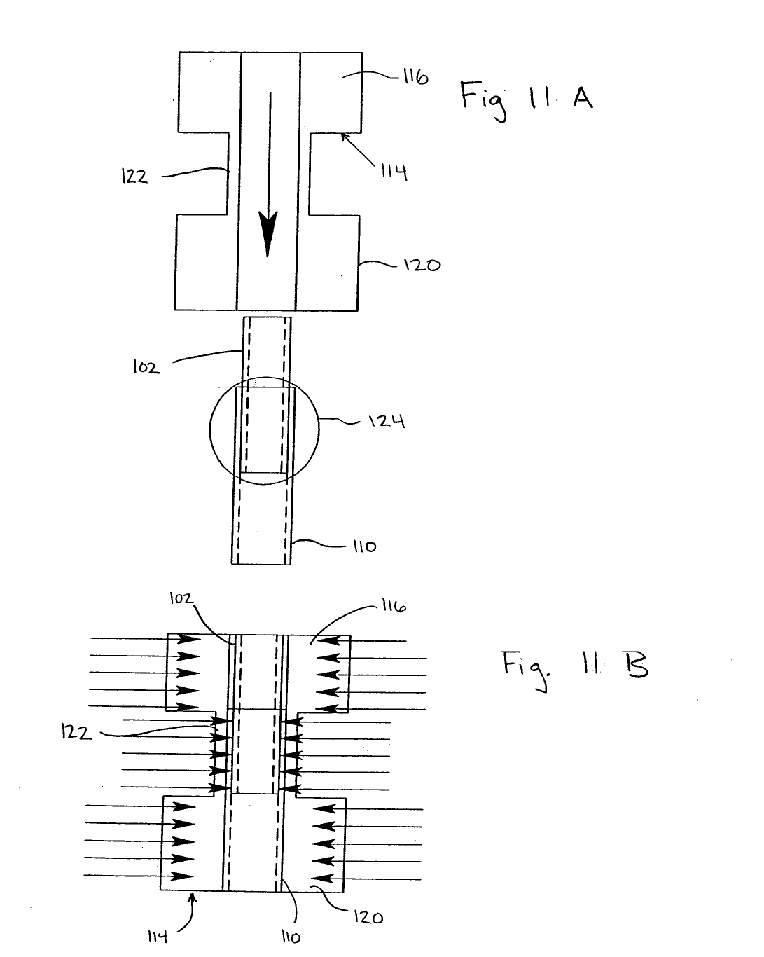

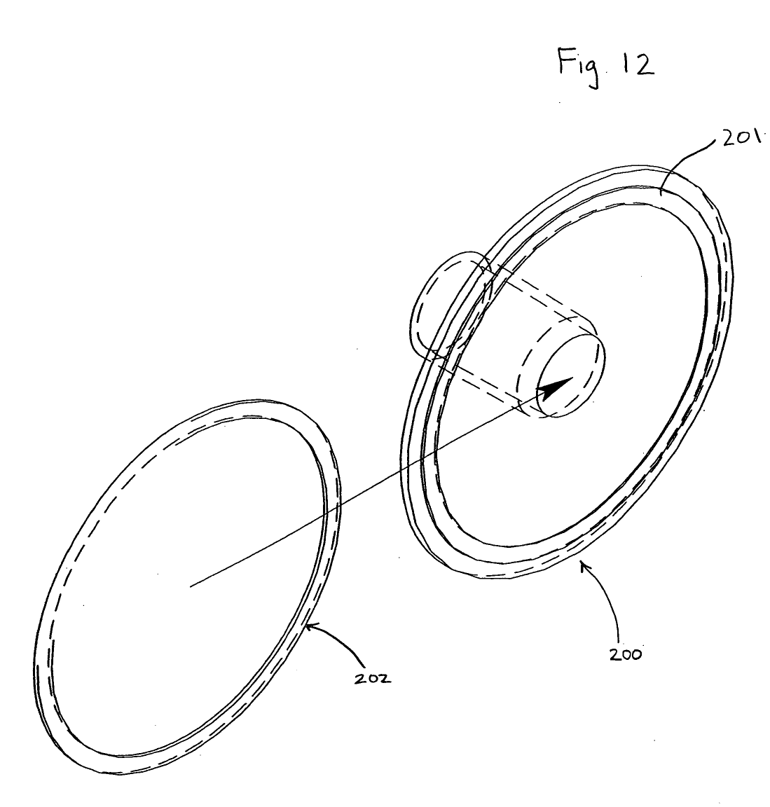

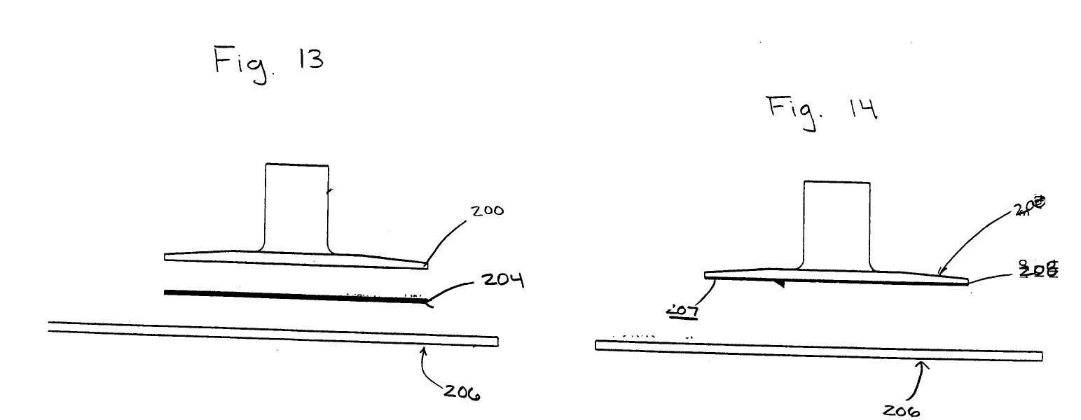

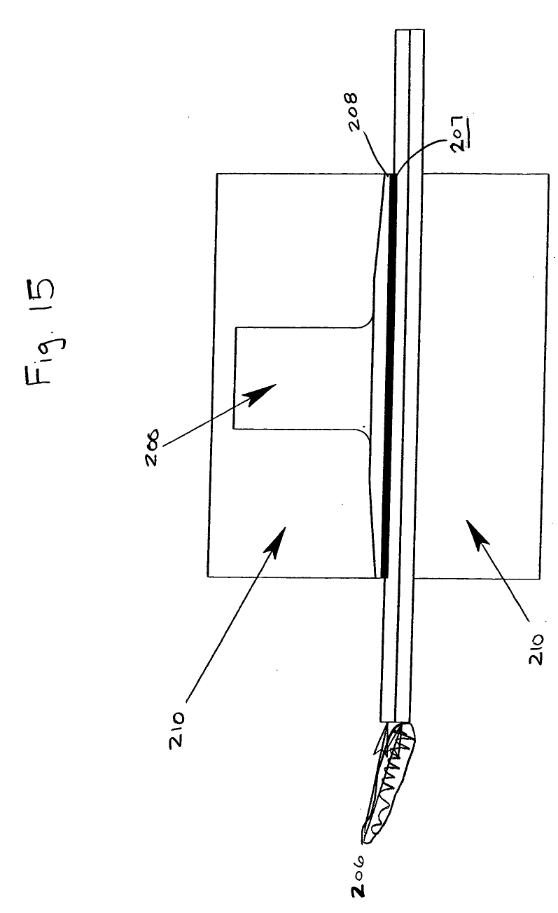

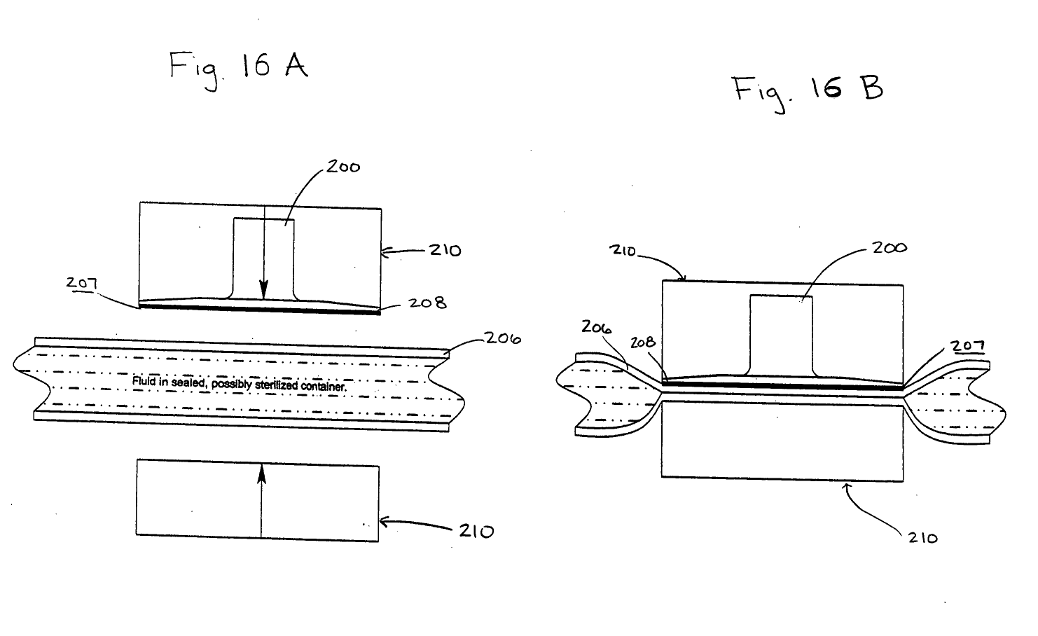

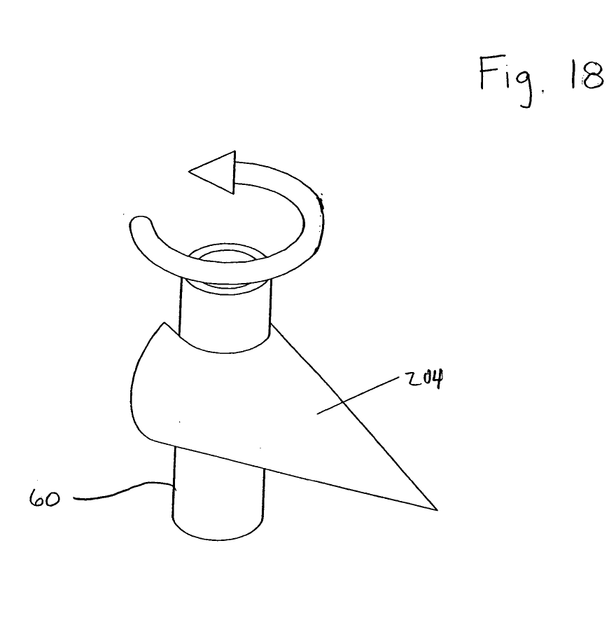

Turning now to FIG. 13, yet another embodiment of the method of the present invention is shown. In this example an infrared responsive pigmented film 204 is provided to facilitate bonding. The infrared responsive pigmented film 204 is designed to be placed in between the flanged port 200 and a second film 206 to which the flanged port 200 is to be welded. The second film 206 is preferably made from any of the polymeric blends discussed above. In a preferred embodiment, the second film 206 is a wall of a sealed sterilized container in either a filled or unfilled state as can be seen in FIG. 15 and FIGS. 16A-B. In cases where the second film 206 is a container, it can include any solution, but most preferably a medical solution such as I.V. solutions, peritoneal dialysis solutions, pharmaceutical drugs, blood, blood components, and blood substitutes to name a few. The infrared responsive pigmented film 204 is preferably compatible with both the polymeric materials of the flanged port 200 and the second film 206. As mentioned above, the infrared responsive pigment can be printed onto the film 204 after fabrication or applied by adding infrared absorbing pigment(s) directly into polymer blends used to make the film 204. Once the infrared responsive pigmented film 204 is placed between the flanged port 200 and the second film 206, the flanged port 200 is then attached to the second film 206. The entire assembly is then exposed to infrared light, and more specifically, to a specific portion of the infrared spectrum where the infrared absorbing pigment(s) absorbs energy. This generates sufficient heat to bond the flanged port 200 to the second film 206.

Referring now to FIG. 14, yet another example of a method according to the present invention is provided. In this example, infrared absorbing pigment 207 is printed onto a bottom surface 208 of the flanged port 200. In an especially preferred example, the pigment is strategically located across several areas of the bottom surface 208, thus providing several distinct bonding sites. The flanged port 200 is then attached to a film 206 and exposed to a specific portion of the infrared spectrum where the pigment(s) absorbs energy, thus generating sufficient heat to create a bond between the flanged port 200 and the film 206.

FIG. 18 shows another embodiment of applying IR responsive material to a member 60 by spraying.

As was the case with polymeric materials discussed above for bonding medical tubing, some materials for use with the flanged port 200 and the second film 206 can stress relieve to create unacceptable distortion during the infrared heat welding process. Thus it may be desirable and/or necessary to use an infrared transmitting block 210 such as the one seen in FIG. 15 and FIGS. 16A-B. The infrared transmitting block 210 is designed to provide a path for sealing light energy as well as pressure to facilitate proper bonding. It is envisioned that the infrared transmitting block 210 could be located on either or both sides of the second film 206. In the case where infrared transmitting blocks 210 are located on both sides of a filled container 212, bringing the two blocks 210 into contact will provide enough pressure to express the fluid in the seal area 214 to create a sealing environment. As is the case with previous examples, the assembly is then exposed to a portion of the infrared spectrum where the infrared pigment(s) absorbs energy in order to create sufficient heat to create a bond.

### EXAMPLES

A port tube and a membrane tube were used to test the bonding strength that can be achieved using the IR sealing techniques described herein. The membrane tube is interference fitted into the larger port tube. The 0.003″ thick outside layer of the membrane tube is a SEBS/polypropylene blend. The 0.006″ thick inside layer is 100% SEBS. Adding known and potential infrared absorbing materials into the outside layer created the variations of the membrane tube used in these examples. The intent was to transmit infrared through the port tube wall into the doped outside layer of the membrane tube to create a weld. Eleven other blends were created to investigate the relative bond strength of different dopants with respect to the carbon black response. The list of variations is detailed in the following table.

| | | | Infrared | | Infrared | Infrared |
|---|---|---|---|---|---|---|
| | | | Bond Peel | Percent | Absorption | Absorption |
| | | | Test Load to | Carbon | at a | at a |
| | | Percent | Failure in | Black Bond | Wavelength | Wavelength |
| | | Concentration | Pounds | Strength | of .83 | of 1.0 |
| Blend | Pigment Description | by Mass | Force | Equivalent | micron | micron |
| 1 | Carbon Black Carbon Black 1 | 0.005 | 5.8 | 0.005 | 0.077 | 0.087 |
| 2 | Carbon Black Carbon Black 1 | 0.01 | 10 | 0.01 | 0.086 | 0.094 |
| 3 | Carbon Black Carbon Black 1 | 0.015 | 13.2 | 0.015 | 0.13 | 0.125 |
| 4 | Carbon Black Carbon Black 1 | 0.02 | 16.2 | 0.02 | 0.115 | 0.121 |
| 5 | Carbon Black Carbon Black 1 | 0.025 | 16.4 | 0.025 | 0.11 | 0.112 |
| 6 | Carbon Black Carbon Black 1 | 0.03 | 20 | 0.03 | 0.126 | 0.12 |
| 7 | Carbon Black Carbon Black 1 | 0.035 | 20.2 | 0.035 | 0.157 | 0.144 |
| 8 | Carbon Black Carbon Black 1 | 0.04 | 20.5 | 0.04 | 0.163 | 0.153 |
| 9 | Carbon Black Carbon Black 1 | 0.045 | 20.3 | 0.045 | 0.145 | 0.158 |
| 10 | Carbon Black Carbon Black 1 | 0.05 | 21.3 | 0.05 | 0.178 | 0.169 |
| 11 | Carbon Black Carbon Black 1 | 0.06 | 21.8 | 0.06 | 0.228 | 0.212 |
| 12 | Carbon Black Carbon Black 1 | 0.07 | 21 | 0.07 | 0.25 | 0.239 |
| 13 | Carbon Black Carbon Black 2 | 0.035 | 18.3 | 0.026 | 0.19 | 0.161 |
| 14 | Carbazole Violet | 0.035 | 9.5 | 0.010 | 0.125 | 0.11 |
| 15 | Ultra-Marine Violet | 0.035 | 6.8 | 0.005 | 0.087 | 0.08 |
| 16 | Ultra-Marine Violet | 0.035 | 7.7 | 0.006 | 0.048 | 0.065 |
| 17 | Carbazole Violet | 0.035 | 12.8 | 0.016 | 0.071 | 0.08 |
| 18 | Violet Dye | 0.035 | 13.7 | 0.018 | 0.062 | 0.061 |
| 19 | Violet Dye | 0.035 | 11.4 | 0.013 | 0.07 | 0.072 |
| 20 | Blue | 0.035 | 10.4 | 0.011 | 0.66 | 0.07 |
| 21 | Nivelles Black Pigment | 0.035 | 12 | 0.014 | 0.071 | 0.076 |
| 22 | Lancer Invisible Cyan 100% | 0.03 | 10.7 | 0.012 | 0.084 | 0.075 |
| 23 | Base 55% Polypropylene/45% Polyethylene | 0 | 8.7 | 0.008 | 0.068 | 0.079 |

The primary equipment for IR welding consists of a pair of halogen lamps focused to a line in space with parabolic mirrors. The lamps emit 1200 watts each at full power with a primary emission in the near infrared of 0.78 to 1 micron wavelength.

Preliminary Feasibility Experiment

The closure system when solvent bonded with cumene and subsequently steam sterilized demonstrates a bond strength of nominally 521 bs tensile. For this study, 3 variations of the membrane tube were created with different amounts of carbon black loading. Standard membrane tubes were manufactured at the same time. Membrane films were then radio frequency welded at the appropriate midway position on the inside of the membrane tubes. The membrane tubes were then assembled into the port tubes to the depth of the membrane location. The samples were infrared welded at an exposure time of 3 seconds. The samples were permitted to cool to ambient conditions. All the samples were then pressure tested to assure that the welding process had not damaged the membrane. For each membrane tube variation assembly 25 samples were tensile tested to failure with an administration spike inserted into the membrane tube to mimic customer use. This represents a green strength of the bond prior to terminal steam sterilization. For comparison, 25 samples of each membrane tube variation assembly were then steam sterilized. Those samples were similarly tensile tested to failure. The results of those tests are summarized in table 1.

TABLE 1

| Percent Concentration | | |
|---|---|---|
| Of Carbon Black by | Non-Sterilized Bond | Steam Sterilized |
| Mass in Membrane Tube | Tensile Strength | Bond Tensile |
| Outside Layer | in Pounds Force | Strength in Pounds Force |
| 0.000 | 35.7 | 43.1 |
| 0.023 | 42.5 | 49.3 |
| 0.046 | 48.7 | 51.8 |
| 0.070 | 50.4 | 52.0 |

These data suggests three distinct aspects of feasibility. The third column shows that for carbon black loadings of 0.046 percent or more a pigment and infrared welding source may be substituted for the solvent bond and achieve the same strength. The last value in the second column suggests that acceptable bond strengths may be obtained without the secondary curing process of the steam sterilization cycle. This could be employed for other products that are terminally sterilized by other means. It is also worth noting that the non-pigmented steam sterilized results are within 20% of the 52 lb target. This is due to the inherent infrared absorbance characteristic of the base resin combined with the heat supplied by the steam sterilization process. This suggests that development could yield an acceptable process where no pigment is required for the infrared weld. Though a seal cycle time of 3.0 seconds was used for this experiment, seal cycle times lower than 0.6 seconds have been recorded for specific applications.

Bond Strength as a Function of Carbon Black Loading

In this experiment the relative bond strength of the closure assembly as a function of carbon black loading in the outside layer of the membrane tube was examined. A set of experimental conditions was created to reduce variables acting on the created seal and still yield a response over the pigment loading range. Twelve different loadings by mass were created using a common carbon black source and carrier resin. The membrane tubes were assembled into the port tubes using water as an assembly lubricant. The assemblies were permitted to thoroughly dry before welding. No membrane films were added to the assemblies and steam sterilization was not included in the experiment as their effects were examined in the preliminary feasibility experiments. The welding equipment was modified to include mirrors to better distribute the line focused infrared energy over the circular weld target area.

The welding time of 2.9 seconds was experimentally determined to provide a response for all the pigment loadings. For each loading 25 samples were welded. As the structures are multilayer co-extrusions it is always possible to peel test the bond to failure. Peel tests generally have lower yields than sheer tests of identical samples as peel tests fail the sample sequentially rather than all at once with a sheering bond yield. Peel tests can be used to provide a relative comparison of weld bond strengths. All the welded closure samples were cut in half along the long axis. Each half was then tensile tested to failure with the sum of the results for the halves of each sample recorded. This was done to minimize the effects of sample preparation. A plot of relative seal strength as a function of carbon black loading is shown in FIG. 19.

FIG. 19 indicates a significant increase in bond strength with increasing carbon black loading up to 0.03% for this closure design. After 0.03% the addition of carbon black does not significantly change the bond strength response suggesting a functional saturation is achieved.

Comparison of Other Pigments to Carbon Black

Carbon black is generally regarded as an ideal absorber of light energy. The appearance of a carbon black tinted medical product may encounter marketing resistance. It is possible that a more appealing color that is infrared responsive could be employed in an infrared welded design. Ten other pigments were create and evaluated with the blends 1 through 12 that established the characteristic curve shown in FIG. 19. Blends 13 through 21 were evaluated at a concentration of 0.035% by mass. Blend 22 was evaluated as a concentration of 0.03% by mass due to the limited amount of pigment available. The pigments of blends 14 through 22 were chosen as pigments reflecting color at the blue/violet end of the visible spectrum. Pigment 13 was an alternatively sourced carbon black. The intent was to compare the alternate pigments to the carbon black reference of FIG. 19 to describe their behavior. The resulting bond strengths can be found in the table above. Those bond strengths were then substituted into the equation for the line of FIG. 19 to determine their equivalence in carbon black concentration. Blends 15 and 16 were of an Ultra-Marine Violet and were functionally equivalent to a non-pigmented closure assembly. The remaining blends between 13 and 21 at 0.035% concentration provided bond strengths comparable to carbon black concentrations ranging from 0.010 to 0.015%. Blend 22 is unique in that the pigment is generally not perceivable by the human eye but does elevate bond response above the base resin. This suggests that carbon black can be replaced by alternative pigments for infrared welding though a higher concentration will be required.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A method for assembling a medical device comprising:
providing a first article of a polymeric material;
providing a second article of a polymeric material;
contacting the first article with the second article along an interface area; and
exposing the first article and the second article to a specific portion of the infrared spectrum where the polymeric material of the first article and the polymeric material of the second article absorb infrared energy in order to generate sufficient heat to create a bond between the first article and the second article.

2. The method of claim 1, further comprising the step of:
providing a shield which fits over a portion of the interface area, the shield allowing infrared exposure to reach the interface area while protecting a non-bonding area.

3. The method of claim 2, wherein the shield comprises polytetrafluoroethylene.

4. The method of claim 1, wherein the first article is a medical housing and the second article is a medical tubing.

5. The method of claim 1, wherein the first article is a medical tubing and the second article is a medical tubing.

6. The method of claim 1, wherein the first article is a film and the second article is a flanged port.

7. The method of claim 1, wherein the first article is a sealed container and the second article is a flanged port.

8. The method of claim 7, wherein the sealed container is filled with a solution.

9. The method of claim 8, wherein the solution is a medical solution.

10. A medical device produced by the method of claim 1.

11. A method for assembling a medical device comprising:
providing a first article of a polymeric material;
providing a second article of a polymeric material;
attaching the first article to the second article along an interface area; and
exposing either the first or the second article to a specific portion of the infrared spectrum where the polymeric material of the first article or the polymeric material of the second article absorb infrared energy in order to generate sufficient heat to create a bond between the first and the second article.

12. The method of claim 11, further comprising the step of:
providing a shield which fits over a portion of the interface area, the shield allowing infrared exposure to reach the interface area while protecting a non-bonding area.

13. The method of claim 12, wherein the shield comprises polytetrafluoroethylene.

14. The method of claim 11, wherein the first article is a medical housing and the second article is a medical tubing.

15. The method of claim 11, wherein the first article is a medical tubing and the second article is a medical tubing.

16. The method of claim 11, wherein the first article is a film and the second article is a flanged port.

17. The method of claim 11, wherein the first article is a sealed container and the second article is a flanged port.

18. The method of claim 17, wherein the sealed container is filled with a solution.

19. The method of claim 18, wherein the solution is a medical solution.

20. A medical device produced by the method of claim 11.

21. A method for assembling a medical device comprising the steps of:
providing a first article of a polymeric material;
providing a second article of a polymeric material;
applying an infrared absorbing pigment to one of the first article or the second article to define an interface area;
contacting the first article with the second article along the interface area; and
bonding the first article to the second article along the interface area using infrared exposure.

22. The method of claim 21, wherein the infrared absorbing pigment comprises carbon black.

23. The method of claim 21, wherein the infrared absorbing pigment comprises activated charcoal.

24. The method of claim 21, wherein the infrared absorbing pigment is blended into the polymeric material of the first article or the second article.

25. The method of claim 21, wherein the infrared absorbing pigment is printed on the first article or the second article.

26. The method of claim 21, wherein the infrared absorbing pigment is placed on a first portion of a surface of the first or second article in a first concentration and in a second portion of the surface in a second concentration lower than the first concentration.

27. The method of claim 26, further comprising the step of applying a first infrared exposure to the first portion of the surface to create a seal.

28. The method of claim 27, further comprising the step of applying a second infrared exposure higher than the first infrared exposure to the second portion of the surface to create a second seal.

29. The method of claim 21, wherein the first article is a medical housing and the second article is a medical tubing.

30. The method of claim 21, wherein the first article is a medical tubing and the second article is a medical tubing.

31. The method of claim 21, wherein the first article is a film and the second article is a flanged port.

32. The method of claim 21, wherein the first article is a sealed container and the second article is a flanged port.

33. The method of claim 32, wherein the sealed container is filled with a solution.

34. The method of claim 33, wherein the solution is a medical solution.

35. The method of claim 21, further comprising the step of:
providing a shield which fits over a portion of the interface area, the shield allowing infrared exposure to reach the interface area while protecting a non-bonding area.

36. The method of claim 35, wherein the shield is made of glass.

37. The method of claim 35, wherein the shield is made of polytetrafluoroethylene.

38. The method of claim 37, wherein the shield includes multiple slots arranged along an axis for allowing the infrared light to reach the interface area and provide multiple sealing areas.

39. The method of claim 21, wherein the bonding step is performed using infrared lamps.

40. The method of claim 21, wherein the bonding step is performed using a laser.

41. A method for assembling a medical device comprising the steps of:
providing a first article of a polymeric material;
providing a second article of a polymeric material;
applying an infrared absorbing pigment to the first article and the second article to define an interface area;
contacting the first article with the second article along the interface area; and
bonding the first article to the second article along the interface area using infrared exposure.

42. The method of claim 41, wherein the first article is a medical tubing and the second article is a medical tubing.

43. The method of claim 41, wherein the infrared absorbing pigment is blended with the polymeric material from which the first article and the second article are derived.

44. The method of claim 41, wherein the infrared absorbing pigment is printed on the first and second article.

45. The method of claim 41, wherein the infrared absorbing pigment is placed on a first portion of a surface of the first or second article in a first concentration and in a second portion of the surface in a second concentration lower than the first concentration.

46. The method of claim 45, further comprising the step of applying a first infrared exposure to the first portion of the surface to create a seal.

47. The method of claim 46, further comprising the step of applying a second infrared exposure higher than the first infrared exposure to the second portion of the surface to create a second seal.

48. The method of claim 41, further comprising the step of: providing a shield which fits over a portion of the interface area, the shield allowing infrared exposure to reach the interface area while protecting a non-bonding area.

49. The method of claim 48, wherein the shield is made of polytetrafluoroethylene.

50. The method of claim 49, wherein the shield includes multiple slots arranged along an axis for allowing the infrared light to reach the interface area and provide multiple sealing areas.

51. A method for assembling a medical device comprising:
providing a first article of a polymeric material;
providing a second article of a polymeric material;
providing an infrared responsive pigmented film;
placing the infrared responsive pigmented film between the first article and the second article to define an interface area and contacting the first article with the second article; and
applying infrared exposure to bond the first article and the second article.

52. The method of claim 51, wherein the first article is a flanged port and the second article is a film.

53. The method of claim 51, wherein the first article is a sealed container and the second article is a flanged port.

54. The method of claim 53, wherein the sealed container is filled with a solution.

55. The method of claim 54, wherein the solution is a medical solution.

56. The method of claim 51, further comprising the step of providing a protective shield which fits over a portion of the interface area, the shield allowing the infrared exposure to reach the interface area while protecting a non-bonding area.

57. The method of claim 56, wherein the shield is made of polytetrafluoroethylene.

58. The method of claim 57, wherein the shield includes multiple slots arranged along an axis for allowing the infrared light to reach the interface area and provide multiple sealing areas.

59. A medical device assembly comprising:
a first article of a polymeric material;
a second article of a polymeric material;
the first or second article having an infrared absorbing pigment disposed thereon to define an interface area, the first article being contacted with the second article at the interface area; and
a protective shield temporarily placed over at least a portion of the interface area, such that when infrared heat is applied to the interface area a bond is formed between the first article and the second article.

60. The medical device assembly of claim 59, wherein the first article is a medical tubing and the second article is a medical housing.

61. The medical device assembly of claim 59, wherein the first article is a medical tubing and the second article is a medical tubing.

62. The medical device assembly of claim 59, wherein the first article is a film and the second article is a flanged port.

63. The medical device assembly of claim 59, wherein the first article is a sealed container and the second article is a flanged port.

64. The medical device assembly of claim 63, wherein the sealed container is filled with a solution.

65. The medical device assembly of claim 64, wherein the solution is a medical solution.

66. The medical device assembly of claim 59, wherein the shield is made of polytetrafluoroethylene.

67. The medical device assembly of claim 66, wherein the shield includes multiple slots arranged along an axis for allowing the infrared light to reach the interface area and provide multiple sealing areas.

68. The medical device assembly of claim 59, wherein the infrared absorbing pigment is placed on a first portion of a surface of the first or second article in a first concentration and in a second portion of the surface in a second concentration lower than the first concentration.

69. The medical device assembly of claim 59, wherein the infrared absorbing pigment comprises carbon black.

70. The medical device assembly of claim 59, wherein the infrared absorbing pigment comprises activated charcoal.

71. The medical device assembly of claim 59, wherein the infrared absorbing pigment is blended with the polymeric material from which the first article and the second article are derived.

72. The medical device assembly of claim 59, wherein the infrared absorbing pigment is printed on the first or second article.

73. A medical device assembly comprising:
a first article of a polymeric material;
a second article of a polymeric material;
the first and second article having an infrared absorbing pigment disposed thereon to define an interface area, the first article being contacted with the second article at the interface area; and
a protective shield temporarily placed over at least a portion of the interface area, such that when infrared heat is applied to the interface area a bond is formed between the first and second article.

74. The medical device assembly of claim 73, wherein the infrared absorbing pigment is blended with the polymeric material from which the first article and the second article are derived.

75. The medical device assembly of claim 74, wherein the infrared absorbing pigment is printed on the first or second article.

76. A medical device assembly comprising:
a first article of a polymeric material;
a second article of a polymeric material;
either the first or second article having an infrared absorbing pigment disposed thereon to define an interface area, the first article being fixedly attached to the second article at the interface area by applying infrared exposure.
